(19) United States
(12) Patent Application Publication
(10) Pub. No.: US 2016/0094659 A1
(43) Pub. Date: Mar. 31, 2016

(54) INFORMATION PROCESSING SYSTEM AND INFORMATION PROCESSING METHOD

(71) Applicant: Ryoh SHIMOMOTO, Kanagawa (JP)

(72) Inventor: Ryoh SHIMOMOTO, Kanagawa (JP)

(73) Assignee: RICOH COMPANY, LTD., Tokyo (JP)

(21) Appl. No.: 14/856,714

(22) Filed: Sep. 17, 2015

(30) Foreign Application Priority Data
Sep. 25, 2014 (JP) 2014-194564
Sep. 4, 2015 (JP) 2015-175139

(51) Int. Cl. H04L 29/08; H04L 29/06

(52) U.S. Cl. CPC H04L 67/1097; H04L 67/42

(57) ABSTRACT

An information processing system includes an information processing terminal connected to a first network and an information processing apparatus, and an information storage device connected to a second network. The information processing terminal acquires a file requested by file-request-data, manages file-identification-data identifying a file to be stored in the information processing terminal for a period, receives update-report-data that is reported when the file stored in the information storage device, which corresponds to the file identified by the file-identification-data, is updated, performs an update process on the file identified by the file-identification-data, by update-data based on the update-report-data, and sends update-request-data for requesting the update-data, the file-request-data, and the file-identification-data. The information storage device receives the file-identification-data from the information processing apparatus, stores the file, and sends a report to the information processing apparatus when the file identified by the file-identification-data, among the stored files, is updated.

### BACKGROUND OF THE INVENTION

1. Field of the Invention

The present invention relates to an information processing system and an information processing method.

2. Description of the Related Art

Conventionally, there is known a method in which an information processing terminal acquires a file included in a server via a network, and the acquired file is used in the information processing terminal.

There is known a method in which, edited contents are stored in the resource of a web application, and when a communication terminal executes the web application, the resource of the web application is provided to the communication terminal (see, for example, Patent Document 1).

However, in the conventional method, a relay process is not performed by a relay device, etc., and therefore it is difficult to improve the security of the file, etc., being used.

Patent Document 1: Japanese Laid-Open Patent Publication No. 2012-216162

Patent Document 2: Japanese Laid-Open Patent Publication No. 2011-253497

### SUMMARY OF THE INVENTION

The present invention provides an information processing system and an information processing method, in which one or more of the above-described disadvantages are eliminated.

According to an aspect of the present invention, there is provided an information processing system including an information processing terminal connected to a first network; at least one information processing apparatus connected to the first network; and an information storage device connected to a second network other than the first network, the information storage device being configured to store a file, wherein the information processing terminal includes an acquisition unit configured to perform an acquisition process of acquiring the file requested by file request data for requesting the file, a management unit configured to manage file identification data for identifying a file to be stored in the information processing terminal for a predetermined period or more than the predetermined period, among the files acquired by the acquisition process, a receiving unit configured to receive update report data that is reported when the file stored in the information storage device, which corresponds to the file identified by the file identification data, is updated, an update unit configured to perform an update process on the file identified by the file identification data among the files acquired by the acquisition process, by update data for updating based on the update report data, and a sending unit configured to send update request data for requesting the update data in the update process, and the file request data and the file identification data in the acquisition process, wherein the at least one information processing apparatus includes a receiving unit configured to receive, from the information processing terminal, the update request data, the file request data, and the file identification data, an acquisition relay unit configured to perform an acquisition relay process of acquiring the file from the information storage device based on the received file request data, and sending the file acquired from the information storage device to the information processing terminal, an update relay unit configured to perform an update relay process of acquiring the update data from the information storage device based on the received update request data, and sending the update data acquired from the information storage device to the information processing terminal, a report unit configured to send a report including the update report data to the information processing terminal based on a report received from the information storage device, and a sending unit configured to send the received file identification data to the information storage device, and wherein the information storage device includes a receiving unit configured to receive the file identification data from the at least one information processing apparatus, a storage unit configured to store the file, and a report unit configured to send the report to the at least one information processing apparatus when the file identified by the file identification data, among the stored files, is updated.

According to an aspect of the present invention, there is provided an information processing system including an information processing terminal connected to a first network and to at least one information processing apparatus; and an information storage device connected to a second network other than the first network, the information storage device being configured to store a file, wherein the information processing terminal includes an acquisition unit configured to perform an acquisition process of acquiring the file requested by file request data for requesting the file, a management unit configured to manage file identification data for identifying a file to be stored in the information processing terminal for a predetermined period or more than the predetermined period, among the files acquired by the acquisition process, a receiving unit configured to receive update report data that is reported when the file stored in the information storage device, which corresponds to the file identified by the file identification data, is updated, an update unit configured to perform an update process on the file identified by the file identification data among the files acquired by the acquisition process, by update data for updating based on the update report data, and a sending unit configured to send update request data for requesting the update data in the update process, and the file request data and the file identification data in the acquisition process, and wherein the information storage device includes a receiving unit configured to receive the file identification data from the at least one information processing apparatus, a storage unit configured to store the file, and a report unit configured to send a report to the at least one information processing apparatus when the file identified by the file identification data, among the stored files, is updated.

According to an aspect of the present invention, there is provided an information processing method performed by an information processing system, the information processing system including an information processing terminal connected to a first network, at least one information processing apparatus connected to the first network, and an information storage device connected to a second network other than the first network, the information storage device being configured to store a file, the information processing method including performing, by the information processing terminal, an acquisition process of acquiring the file requested by file request data for requesting the file; managing, by the information processing terminal, file identification data for identifying a file to be stored in the information processing terminal for a predetermined period or more than the predetermined period, among the files acquired by the acquisition process; performing, by the information processing terminal, a first receiving step of receiving update report data that is reported when the file stored in the information storage device, which corresponds to the file identified by the file identification data, is updated; performing, by the information processing terminal, an update process on the file identified by the file identification data among the files acquired by the acquisition process, by update data for updating based on the update report data; performing, by the information processing terminal, a first sending step of sending update request data for requesting the update data in the update process, and the file request data and the file identification data in the acquisition process; performing, by the at least one information processing apparatus, a second receiving step of receiving, from the information processing terminal, the update request data, the file request data, and the file identification data; performing, by the at least one information processing apparatus, an acquisition relay process of acquiring the file from the information storage device based on the received file request data, and sending the file acquired from the information storage device to the information processing terminal; performing, by the at least one information processing apparatus, an update relay process of acquiring the update data from the information storage device based on the received update request data, and sending the update data acquired from the information storage device to the information processing terminal; performing, by the at least one information processing apparatus, a first report step of sending a report including the update report data to the information processing terminal based on a report received from the information storage device; performing, by the at least one information processing apparatus, a second sending step of sending the received file identification data to the information storage device; performing, by the information storage device, a third receiving step of receiving the file identification data from the at least one information processing apparatus; storing, by the information storage device, the file; and performing, by the information storage device, a second report step of sending the report to the at least one information processing apparatus when the file identified by the file identification data, among the stored files, is updated.

### BRIEF DESCRIPTION OF THE DRAWINGS

Other objects, features and advantages of the present invention will become more apparent from the following detailed description when read in conjunction with the accompanying drawings, in which:

FIG. 1 illustrates an overall configuration of an example of an information processing system according to a first embodiment of the present invention;

FIG. 2 is a block diagram of an example of a hardware configuration of an information processing terminal according to an embodiment of the present invention;

FIG. 3 is a block diagram of an example of a hardware configuration of an information processing apparatus and an information storage device according to an embodiment of the present invention;

FIG. 4 is a block diagram of an example of a functional configuration of the information processing terminal according to an embodiment of the present invention;

FIG. 5 is a block diagram of an example of a functional configuration of the information storage device according to an embodiment of the present invention;

FIG. 6 is a block diagram of an example of a functional configuration of the information processing apparatus according to an embodiment of the present invention;

FIG. 7 is a sequence diagram illustrating an example of an overall process by the information processing system according to an embodiment of the present invention;

FIGS. 8A through 8C illustrate examples of displays by the information processing terminal according to an embodiment of the present invention;

FIGS. 9A and 9B illustrate examples of files displayed by the information processing terminal according to an embodiment of the present invention;

FIGS. 10A and 10B illustrate examples of displays relevant to “favorites” displayed by the information processing terminal according to an embodiment of the present invention;

FIG. 11 is a sequence diagram illustrating an example of a process of downloading a file by the information processing system according to an embodiment of the present invention;

FIGS. 12A through 12C are flowcharts of an example of a process of downloading a file performed by the respective devices according to an embodiment of the present invention;

FIG. 13 illustrates an example of the effect of the process of downloading a file by the information processing system according to an embodiment of the present invention;

FIG. 14 is a sequence diagram illustrating an example of a process of registering a file in “favorites” by the information processing system according to an embodiment of the present invention;

FIGS. 15A through 15C are flowcharts of an example of a process of registering a file in “favorites” performed by the respective devices according to an embodiment of the present invention;

FIG. 16 is a sequence diagram illustrating another example of a process of registering a file in “favorites” by the information processing system according to an embodiment of the present invention;

FIG. 17 is a sequence diagram illustrating an example of a process of updating a file by the information processing system according to an embodiment of the present invention;

FIGS. 18A and 18B illustrate examples of displays relevant to the report by the information processing terminal according to an embodiment of the present invention;

FIGS. 19A through 19C are flowcharts of an example of a process of updating a file performed by the respective devices according to an embodiment of the present invention;

FIG. 20 is a functional block diagram of an example of the functional configuration of the information processing system according to an embodiment of the present invention; and

FIG. 21 illustrates an overall configuration of an example of an information processing system according to a second embodiment of the present invention.

### DETAILED DESCRIPTION OF THE PREFERRED EMBODIMENTS

A description is given, with reference to the accompanying drawings, of an information processing system and an information processing method according to an embodiment of the present invention.

### First Embodiment

### System Configuration

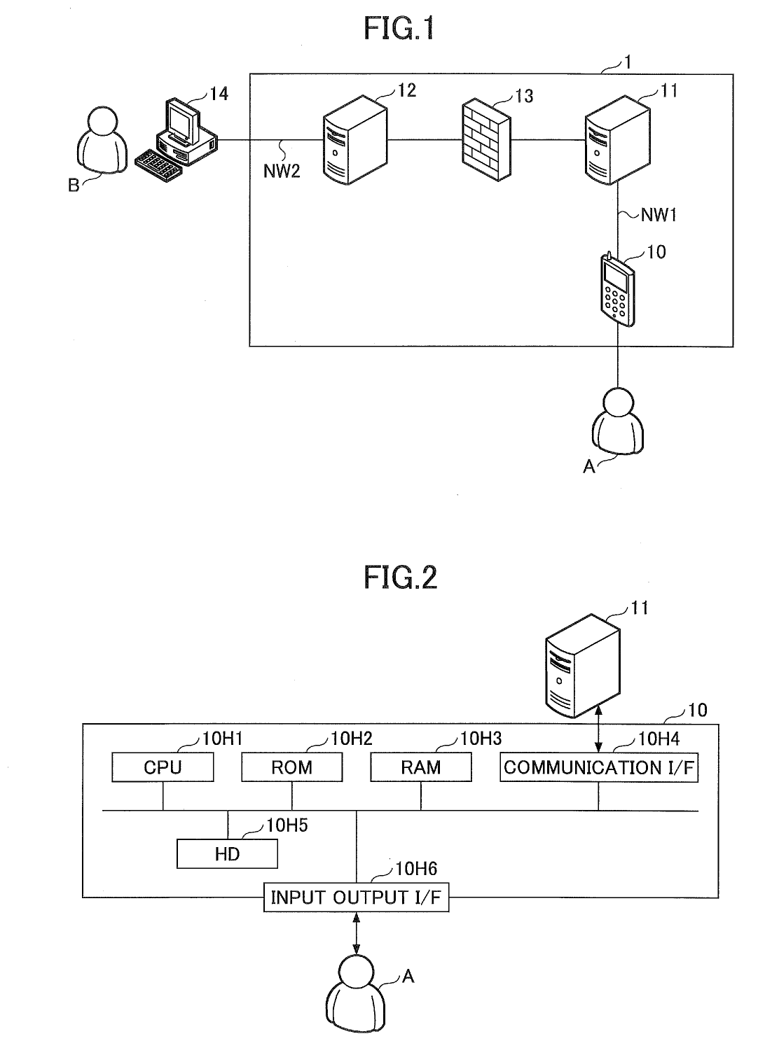

FIG. 1 illustrates an overall configuration of an example of an information processing system according to a first embodiment of the present invention.

An information processing system 1 includes an information processing terminal 10, a server 11, and a file storage 12.

The information processing terminal 10 and the server 11 are connected by the Internet NW1, and exchange data with each other. A first network is, for example, the Internet NW1. In the following, an example is given of a cause where the first network is the Internet NW1. Note that to the Internet NW1, devices other than the information processing terminal 10 may be connected.

To the file storage 12, a PC (Personal Computer) 14 is connected via a local network NW2. A second network is, for example, the local network NW2. In the following, an example is given of a case where the second network is the local network NW2. The local network NW2 is, for example, an intra-company LAN (Local Area Network), etc. Note that to the local network NW2, devices other than the PC 14 may be connected.

A user B, etc., who is the user of the local network NW2 operates the PC 14 to edit, etc., a file included in the file storage 12.

There are cases where the file storage 12 stores files including so-called confidential information, and therefore access to the file storage 12 from devices other than the PC 14, etc., that are connected to the local network NW2, is blocked by a firewall 13.

### <Hardware Configuration of Devices>

FIG. 2 is a block diagram of an example of a hardware configuration of the information processing terminal 10 according to an embodiment of the present invention.

The information processing terminal 10 is, for example, a smartphone, etc. The information processing terminal 10 may be a tablet, a PC, a mobile PC, etc. In the following, an example is given of a case where the information processing terminal 10 is a smartphone.

The information processing terminal 10 includes CPU (Central Processing Unit) 10H1, a ROM (Read-Only Memory) 10H2, and a RAM (Random Access Memory) 10H3. The information processing terminal 10 includes a communication I/F (interface) 10H4, a HD (Hard Disk) 10H5, and an input output I/F 10H6. The hardware elements included in the information processing terminal 10 are interconnected by a bus, and the hardware elements exchange data, etc., with each other.

The CPU 10H1 is an arithmetic device and a control device for realizing various processes performed by the information processing terminal 10, by loading programs, data, etc., from a storage device such as the ROM 10H2 and the HD 10H5 into the RAM 10H3, and executing processes.

The ROM 10H2 is a storage device such as a non-volatile semiconductor memory that can hold the stored programs, data, etc., even after the power is turned off. The ROM 10H2 stores firmware such as the BIOS (Basic Input/Output System) to be executed when the information processing terminal 10 is activated. The ROM 10H2 stores data, programs, etc., relevant to settings of the OS (Operating System) and settings of the network, etc. The OS used in the information processing terminal 10 is, for example, ANDROID (registered trademark).

The RAM 10H3 is a main storage such as a volatile semiconductor memory that can store programs, data, etc.

The communication I/F 10H4 is an interface for connecting the information processing terminal 10 to the network. The communication I/F 10H4 is an antenna, a processing IC (Integrated Circuit), a driver, etc. The communication I/F 10H4 connects the information processing terminal 10 with an external device such as the server 11 via a network and transmits and receives data between the connected external device and the information processing terminal 10.

The HD 10H5 is a secondary storage for storing secondary storage programs, data, etc. The HD 10H5 stores programs such as the OS that is the basic software for controlling the entire information processing terminal 10, application software for providing various functions on the OS, etc.

The input output I/F 10H6 is an input device to which a user A inputs various operations for the information processing terminal 10. The input output I/F 10H6 is an output device for displaying processing results, etc., obtained by executing various processes by the information processing terminal 10. The input output I/F 10H6 is, for example, a touch panel, etc. Note that the input output I/F 10H6 may be realized by combining an input device such as a keyboard and an output device such as a display.

Note that the hardware configuration of the information processing terminal 10 is not limited to that illustrated in FIG. 2. The hardware configuration of the information processing terminal 10 may include, for example, internal devices or external devices for supplementing the hardware elements included in the information processing terminal 10.

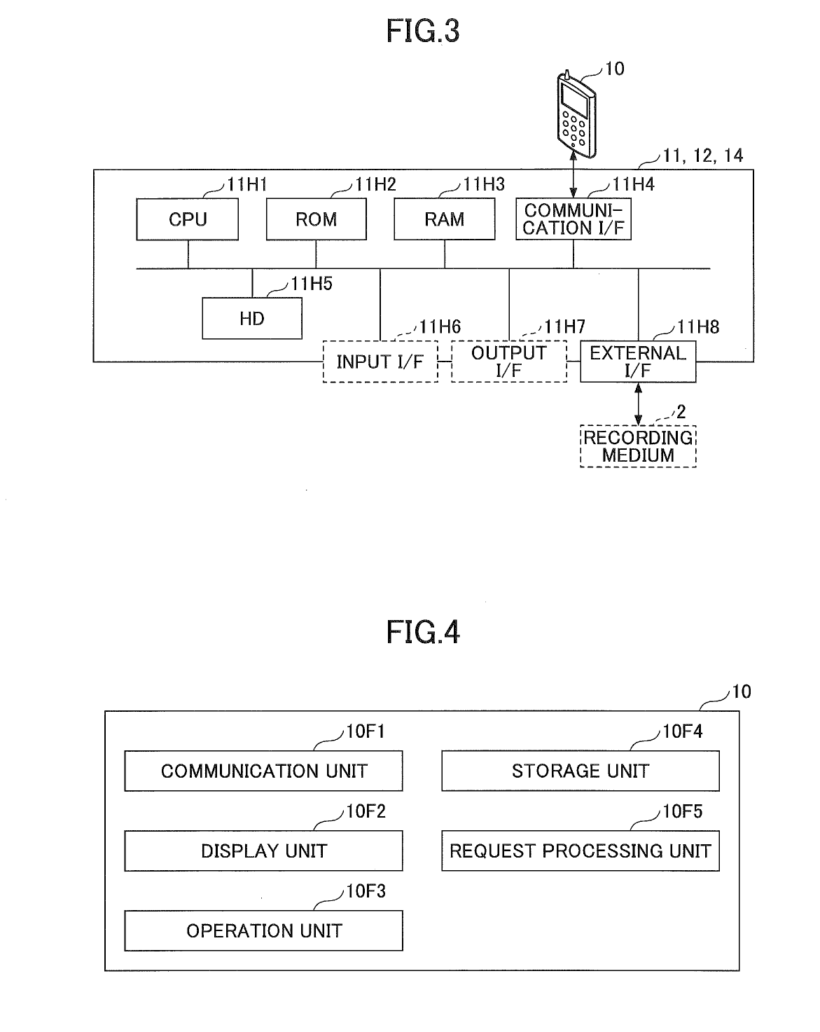

FIG. 3 is a block diagram of an example of a hardware configuration of an information processing apparatus and an information storage device according to an embodiment of the present invention.

The server 11, the file storage 12, and the PC 14 are devices having a hardware configuration as illustrated in FIG. 3, for example. In the following, an example is given of the server 11.

The server 11 includes a CPU 11H1, a ROM 11H2, a RAM 11H3, a communication I/F 11H4, a HD 11H5, an input I/F 11H6, an output I/F 11H7, and an external I/F 11H8. The hardware elements included in the server 11 are interconnected by a bus, and the hardware elements exchange data, etc., with each other.

The CPU 10H1 is an arithmetic device and a control device for realizing various processes performed by the server 11, by loading programs, data, etc., from a storage device such as the ROM 11H2 and the HD 11H5 into the RAM 11H3, and executing processes.

The ROM 11H2 is a storage device such as a non-volatile semiconductor memory that can hold the stored programs, data, etc., even after the power is turned off. The ROM 11H2 stores firmware such as the BIOS to be executed when the server 11 is activated. The ROM 11H2 stores data, programs, etc., relevant to settings of the OS and settings of the network, etc.

The RAM 11H3 is a main storage such as a volatile semiconductor memory that can store programs, data, etc.

The communication I/F 11H4 is an interface for connecting the server 11 to the network. The communication I/F 11H4 is a connector, a communication cable, a processing IC, a driver, etc. The communication I/F 11H4 connects the server 11 with an external device such as the information processing terminal 10 via a network and transmits and receives data between the connected external device and the server 11.

The HD 11H5 is a secondary storage for storing programs, data, etc. The HD 11H5 stores programs such as the OS that is the basic software for controlling the entire server 11, application software for providing various functions on the OS, etc.

The input I/F 11H6 is an input device for inputting various to the server 11. The input I/F 11H6 is a keyboard, a mouse, a touch panel, etc.

The output I/F 11H7 is an output device for displaying processing results, etc., obtained by executing various processes by the server 11. The output I/F 11H7 is a display, etc.

Note that the input device and the output device may be removable by the user.

The external I/F 11H8 is an interface between the server 11 and a recording medium 2, etc. The recording medium 2 is, for example, an optical medium such as a CD-ROM (Compact Disc-Read Only Memory), a USB (Universal Serial Bus) memory, etc. The server 11 inputs and/or outputs data to/from the recording medium 2 by the external I/F 11H8. The external I/F 11H8 is realized by a connector, a process IC, etc.

Note that the hardware configuration of the information processing apparatus and the information storage device is not limited to that illustrated in FIG. 3. The hardware configuration may include, for example, internal devices or external devices for supplementing the hardware elements included in the information processing apparatus and the information storage device. Furthermore, each of the information processing apparatus and the information storage device may not be a single apparatus. For example, the information processing apparatus and the information storage device may be respectively constituted by two or more information processing apparatuses that are connected by a network, etc.

The information processing terminal, the information processing apparatus, and the information storage device may cause an external device connected by a network, etc., to perform part of or all of the processes performed by the information processing terminal, the information processing apparatus, and the information storage device in a parallel manner, in a distributed manner, or in a redundant manner.

### <Functional Configuration of Devices>

FIG. 4 is a block diagram of an example of a functional configuration of the information processing terminal 10 according to an embodiment of the present invention.

The information processing terminal 10 includes a communication unit 10F1, a display unit 10F2, an operation unit 10F3, a storage unit 10F4, and a request processing unit 10F5.

The communication unit 10F1 performs communication with another external device via the network. The communication unit 10F1 is realized by, for example, the communication I/F 10H4.

The display unit 10F2 provides a UI (User Interface) to the user. The display unit 10F2 is realized by, for example, the input output I/F 10H6.

The operation unit 10F3 receives user operations. The operation unit 10F3 is realized by, for example, the input output I/F 10H6.

The storage unit 10F4 stores files, etc. The storage unit 10F4 is realized by, for example, the HD 10H5.

The request processing unit 10F5 transmits requests to other external devices and receives processing results in response to the transmitted request from other external devices. The request processing unit 10F5 is realized by the communication I/F 10H4, etc.

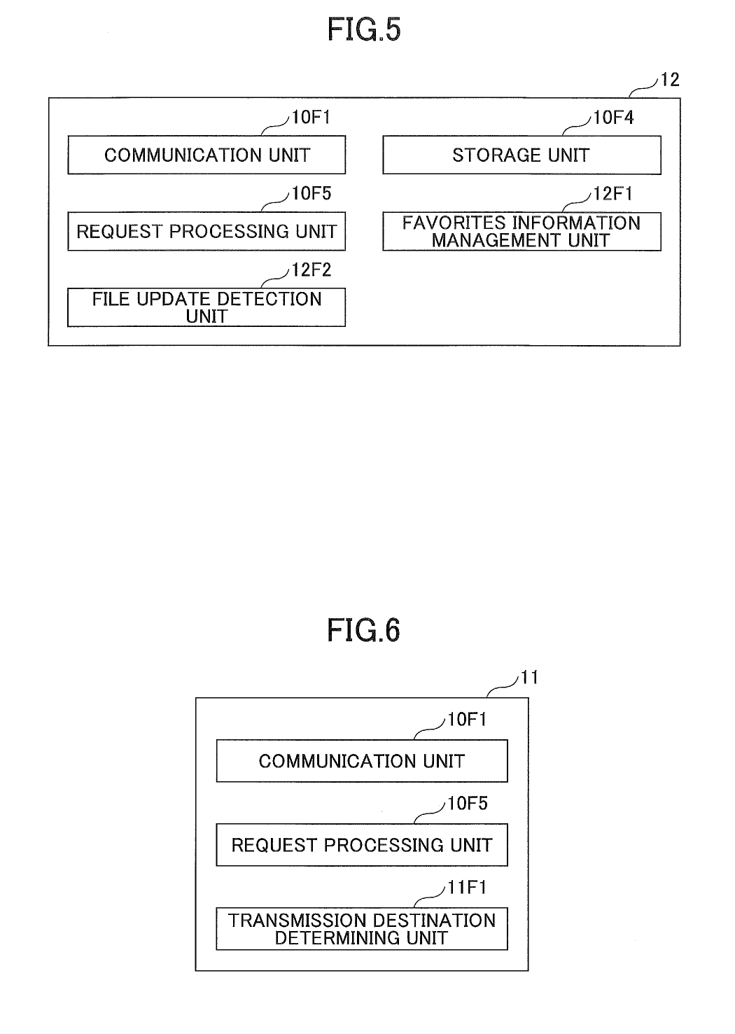

FIG. 5 is a block diagram of an example of a functional configuration of the information storage device according to an embodiment of the present invention.

The file storage 12 includes a communication unit 10F1, a storage unit 10F4, a request processing unit 10F5, a favorites information management unit 12F1, and a file update detection unit 12F2.

The communication unit 10F1, the storage unit 10F4, and the request processing unit 10F5 have the same functions as those of the information processing terminal 10, and are denoted by the same reference numerals, and descriptions thereof are omitted.

The favorites information management unit 12F1 manages files that are registered as “favorites” and data relevant to the information processing terminal 10. The favorites information management unit 12F1 is realized by, for example, the CPU 11H1.

The file update detection unit 12F2 detects that a file has been updated. For example, the file update detection unit 12F2 detects a case where a file stored in the storage unit 10F4 is updated as a user B performs operations such as editing the file by using the PC 14. The file update detection unit 12F2 is realized by, for example, the CPU 11H1.

FIG. 6 is a block diagram of an example of a functional configuration of the information processing apparatus according to an embodiment of the present invention.

The server 11 includes the communication unit 10F1, the request processing unit 10F5, and a transmission destination determining unit 11F1.

The communication unit 10F1 and the request processing unit 10F5 have the same functions as those of the information processing terminal 10, and are denoted by the same reference numerals, and descriptions thereof are omitted.

The transmission destination determining unit 11F1 determines the external device to be the transmission destination of various kinds of data. For example, the transmission destination determining unit 11F1 determines that the transmission destination to which the request processing unit 10F5 sends requests is the file storage 12, or the transmission destination to which the results of processes by the request processing unit 10F5 are to be sent is the information processing terminal 10.

### <Overall Process>

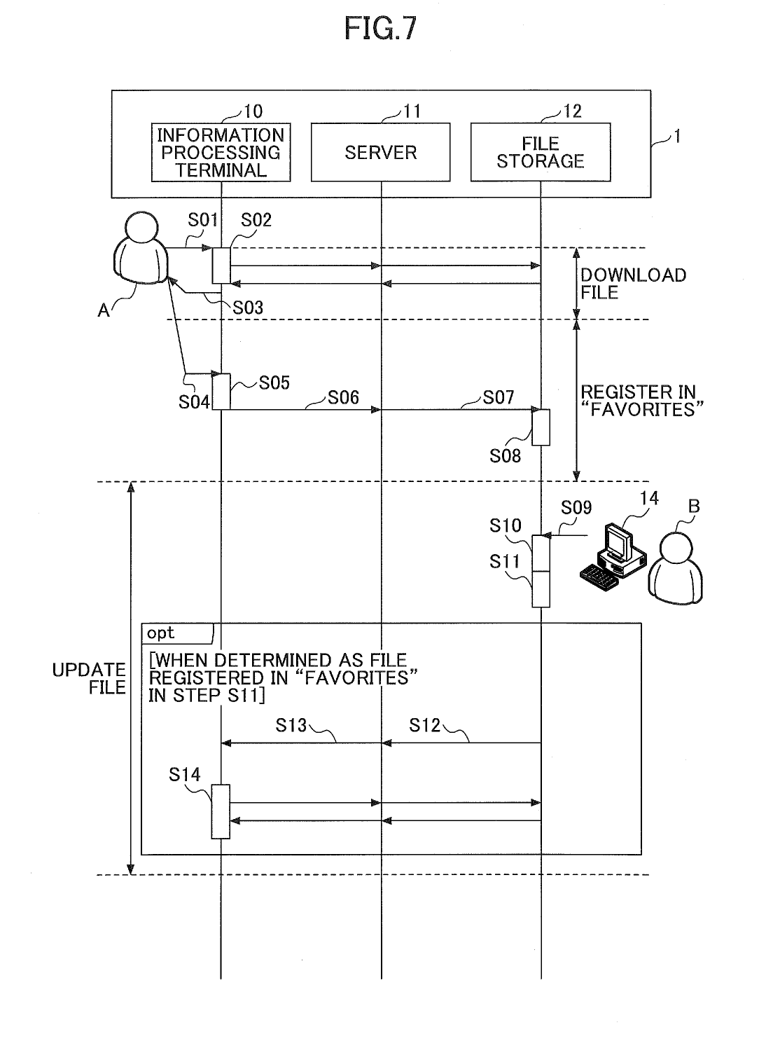

FIG. 7 is a sequence diagram illustrating an example of an overall process by the information processing system 1 according to an embodiment of the present invention.

FIG. 7 illustrates an example where a user A uses the information processing terminal 10 to view a file 3 such as a document, an image, etc., stored in the file storage 12.

The processes of steps S01 through S03 are examples of processes of downloading the file 3 in the information processing terminal 10.

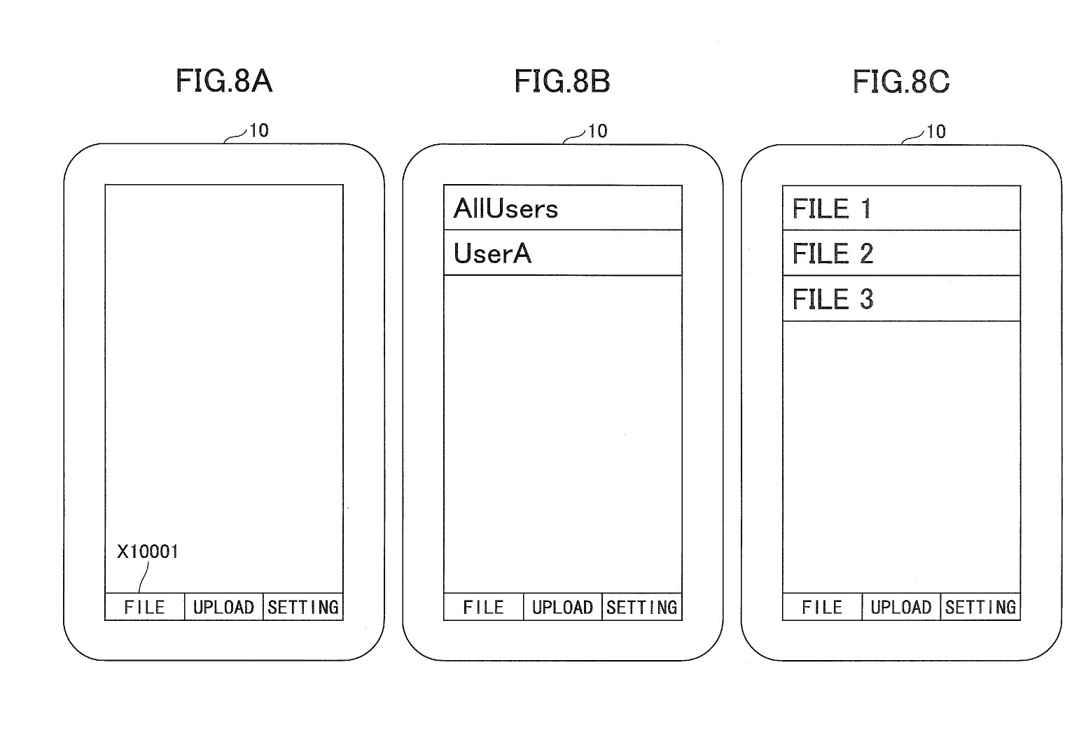

In step S01, the user A performs an operation of viewing the file 3, by the information processing terminal 10. Here, a description is given of a more detailed process, with reference to FIGS. 8A through 8C illustrating examples of screens displayed on the information processing terminal 10.

FIGS. 8A through 8C illustrate examples of displays by the information processing terminal 10 according to an embodiment of the present invention.

First, when an application is activated in the information processing terminal 10, the information processing terminal 10 displays a screen illustrated in FIG. 8A. Next, when the information processing terminal 10 receives a selection of a “file” button X10001 of FIG. 8A, the information processing terminal 10 sends a request to acquire a list of files to the file storage 12 via the server 11. Next, when the file storage 12 receives the acquisition request, the file storage 12 sends the information of the file list and the folder list to the information processing terminal 10 via the server 11. Then, based on the received information of the file list, the information processing terminal 10 displays a screen including the folder list illustrated in FIG. 8B. Next, when the information processing terminal 10 receives a selection of an “AllUsers” folder among the folders in the displayed folder list, the information processing terminal 10 acquires information of the file list in “AllUsers” from the file storage 12 via the server 11. Then, the information processing terminal 10f displays a screen including the file list as illustrated in FIG. 8C. Then, the information processing terminal 10 receives a selection of the file 3 from the file list displayed on the information processing terminal 10.

In step S02, the information processing terminal 10 performs an acquisition process of acquiring the file 3. In step S02, the information processing terminal 10 performs an acquisition process of acquiring the file 3 that is the target of viewing by the user A.

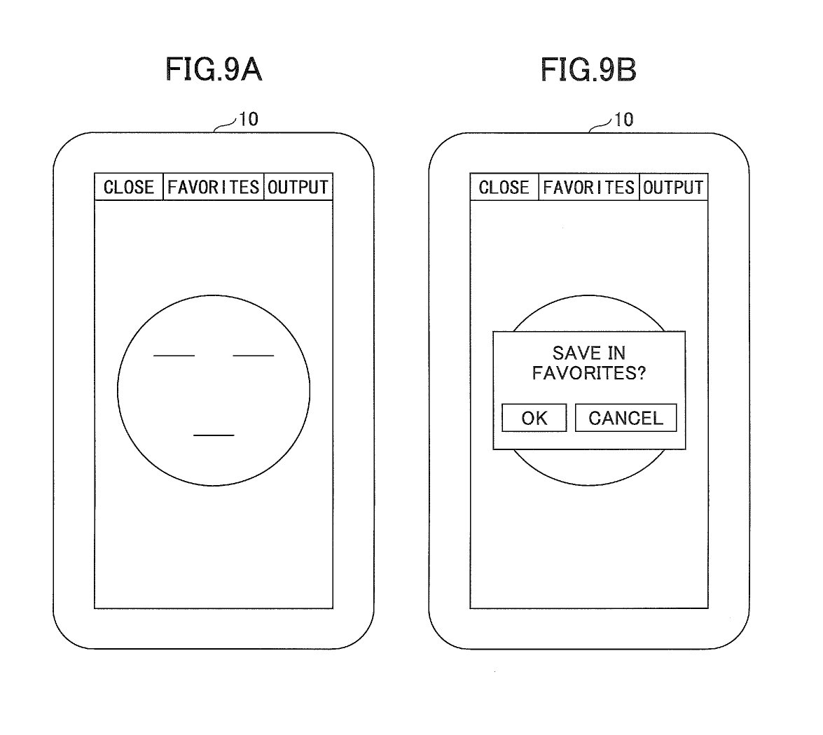

In step S03, the information processing terminal 10 performs a process of displaying the file 3 acquired by the acquisition process, to the user A. A screen example in which a file is displayed by the information processing terminal 10 is illustrated in FIG. 9A. FIGS. 9A and 9B illustrate examples of files displayed by the information processing terminal 10 according to an embodiment of the present invention.

The information processing terminal 10 performs a process of registering a file 3 specified by the user A in “favorites”, from among the files 3 that have been downloaded in the information processing terminal 10 by a process of downloading files. The processes of steps S04 through S08 are an example of a process of registering files in “favorites”.

In step S04, the user A performs an operation of specifying the file 3 to be registered in “favorites”, by the information processing terminal 10. For example, as illustrated in FIG. 9A, a selection of a “favorites” button displayed by the information processing terminal 10 is received, and a selection of an “OK” button in FIG. 9B is received.

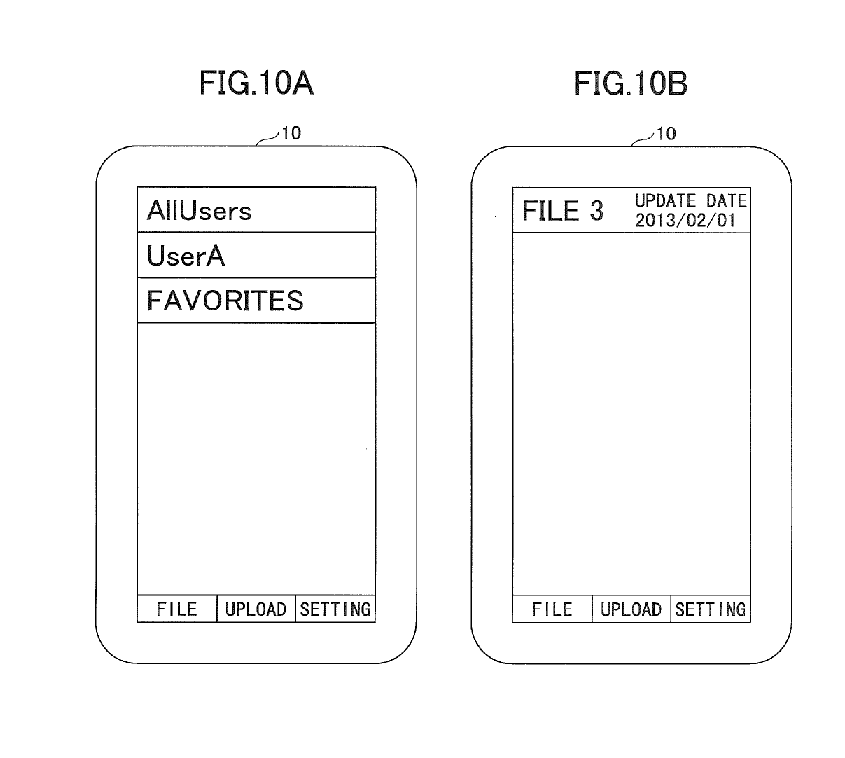

Then, the information processing terminal 10 stores the selected file 3 in the storage unit 10F4 of the information processing terminal 10. The file 3 registered in “favorites” may be selected from the “favorites” folder displayed in the same row as the list of folders of the file server as illustrated in FIG. 10A. Then, when the “favorites” folder is selected, as illustrated in FIG. 10B, the information processing terminal 10 displays a list of files registered in “favorites”.

FIGS. 10A and 10B illustrate examples of displays relevant to “favorites” displayed by the information processing terminal 10 according to an embodiment of the present invention.

In step S05, the information processing terminal 10 generates file identification data for identifying the file 3 to be registered in “favorites”, which has been specified in step S04.

In step S06, the information processing terminal 10 sends the file identification data generated in step S05, to the server 11.

In step S07, the server 11 sends the file identification data sent from the information processing terminal 10 in step S06, to the file storage 12.

In step S08, the file storage 12 stores the file identification data sent from the server 11 in step S07.

The information processing terminal 10 performs a process of updating the file, which is a process of updating the file 3 registered in “favorites” by the process of registering a file in “favorites”. The processes of step S09 through S14 is an example of a process of updating a file.

In step S09, a user B performs an operation of updating the file 3 stored in the file storage 12, by the PC 14.

In step S10, the file storage 12 detects the updating of the file 3 in step S09. The updating is, for example, a process of overwriting the file 3 stored in the file storage 12 with a new file by the file storage 12, based on the operation of step S09. In step S10, the file storage 12 detects that the file 3 stored in the file storage 12 has been updated by the operation of step S09.

In step S11, the file storage 12 determines whether the file 3 that is detected as being updated in step S10, is a file registered in “favorites”. The process of step S11 is performed based on the file identification data stored in step S08.

When the file storage 12 determines that the file 3 that is detected as being updated in step S10, is a file registered in “favorites” (when the file is determined to be a file registered in “favorites” in step S11), the processes of step S12 and onward are performed.

### <Process of Downloading File>

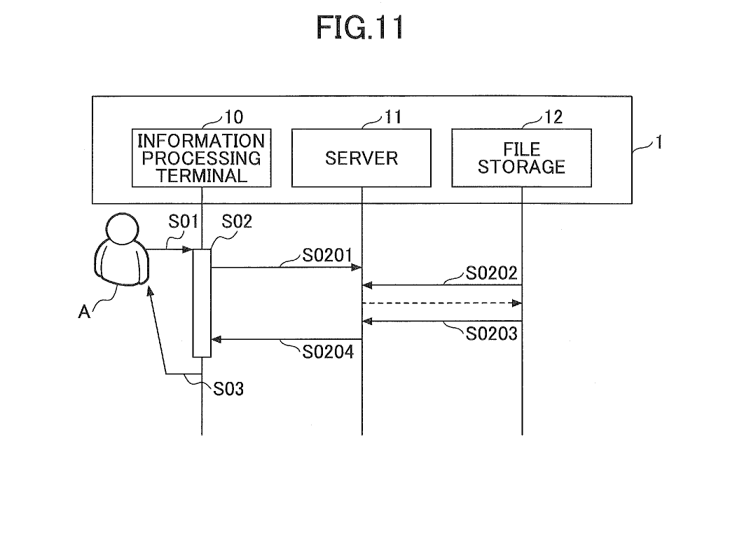

FIG. 11 is a sequence diagram illustrating an example of a process of downloading a file by the information processing system 1 according to an embodiment of the present invention.

The processes illustrated in FIG. 11 are detailed processes of steps S04 through S03.

In step S01, when the user A performs an operation of viewing the file 3, the information processing terminal 10 performs an acquisition process in step S02.

The acquisition process is, for example, processes of steps S0201 through S0204.

In step S0201, the information processing terminal 10 sends file request data requesting the file 3, to the server 11. The file request data is data for the information processing terminal 10 to request the file 3 stored in the file storage 12.

The server 11 performs an acquisition relay process when the file request data is sent from the information processing terminal 10. The acquisition relay process by the server 11 is a process of acquiring, from the file storage 12, the file 3 requested by the file request data, and sending the file 3 acquired from the file storage 12 to the information processing terminal 10.

The acquisition relay process is, for example, processes of steps S0202 through S0204.

In step S0202, the file storage 12 performs a process of acquiring the request for the file. By the process of step S0202, the file request data sent to the server 11 in step S0201 is sent to the file storage 12.

In step S0203, the file storage 12 sends the file 3 to the server 11 based on the file request data. In step S0203, the file storage 12 sends, to the server 11, the file 3 stored in the file storage 12, based on the file request data acquired in step S0202.

In step S0204, the server 11 sends the file 3 acquired based on the file request data, to the information processing terminal 10.

In step S03, the information processing terminal 10 performs a process of displaying the file 3 acquired by the acquisition process.

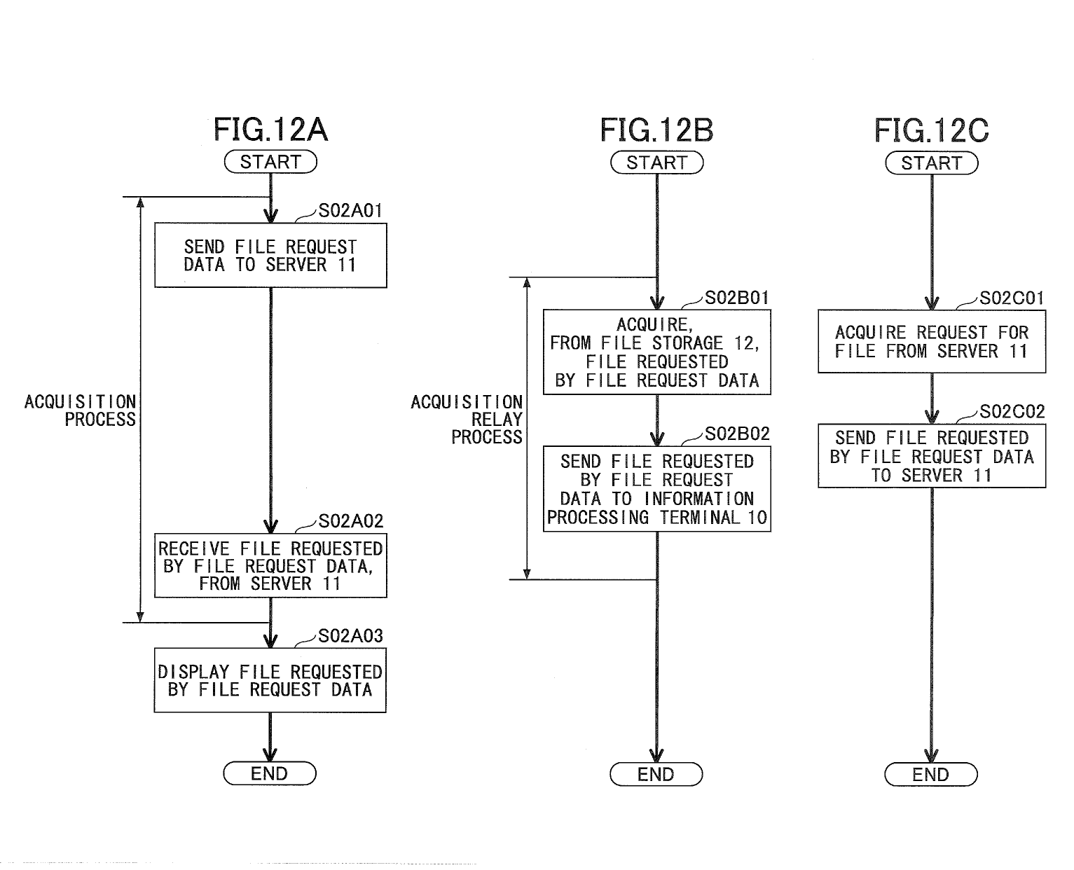

FIGS. 12A through 12C are flowcharts of an example of a process of downloading a file performed by the respective devices according to an embodiment of the present invention.

FIG. 12A is a flowchart of an example of a process of downloading a file performed by the information processing terminal 10 according to an embodiment of the present invention.

In step S02A01, the information processing terminal 10 sends the file request data to the server 11. The process of step S02A01 corresponds to the process of step S0201.

In step S02A02, the information processing terminal 10 receives the file 3 requested by the file request data, from the server 11. The process of step S02A02 corresponds to the process of step S0204.

The processes of steps S02A01 and S02A02 are examples of an acquisition process.

In step S02A03, the information processing terminal 10 displays the file 3 requested by the file request data. The process of step S02A03 corresponds to the process of step S03.

FIG. 12B is a flowchart of an example of a process of downloading a file performed by the server 11 according to an embodiment of the present invention.

In step S02B01, the server 11 acquires, from the file storage 12, the file 3 requested by the file request data.

In step S02B02, the server 11 sends the file 3 acquired in step S02B01 to the information processing terminal 10. The process of step S02B02 corresponds to the process of step S0204.

The processes of steps S02B01 and S02B02 are examples of an acquisition relay process.

FIG. 12C is a flowchart of an example of a process of downloading a file performed by the file storage 12 according to an embodiment of the present invention.

In step S02C01, the file storage 12 acquires the request for the file 3 from the server 11. The process of step S02C01 corresponds to the process of step S0202.

In step S02C02, the file storage 12 sends the file 3 requested by the file request data, to the server 11. The process of step S02C02 corresponds to the process of step S0203.

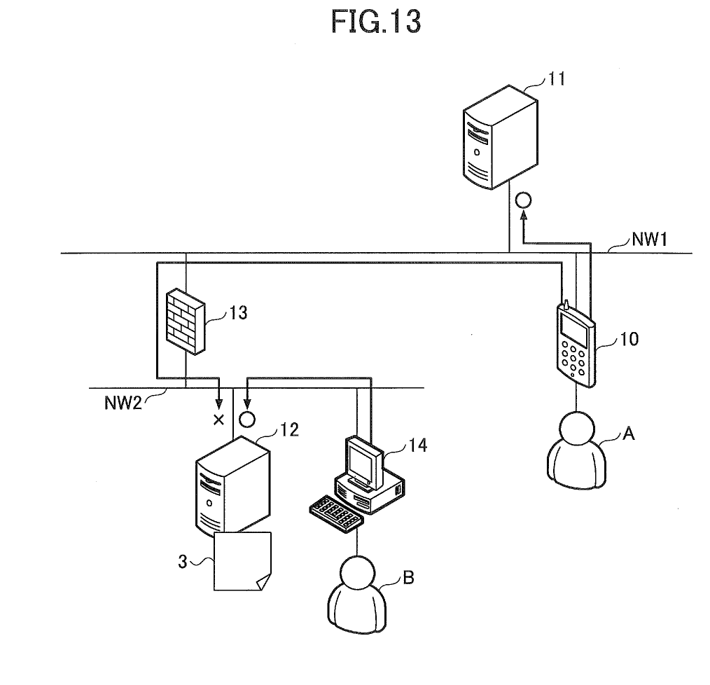

FIG. 13 illustrates an example of the effect of the process of downloading a file by the information processing system 1 according to an embodiment of the present invention.

A firewall 13 protects the file storage 12. In order to increase the security of the file storage 12, the firewall 13 blocks access from the information processing terminal 10, etc., via the Internet NW1.

As illustrated in FIG. 13, for example, the firewall 13 blocks access from the information processing terminal 10, etc., via the Internet NW1. Meanwhile, the firewall 13 does not block access from the PC 14 via the local network NW2. Therefore, the user B is able to use the file 3 stored in the file storage 12 by operating the PC 14.

In FIG. 13, when the user A wants to use the file 3 included in the file storage 12, the user A performs an operation of causing the information processing terminal 10 to perform an acquisition process of acquiring the file 3. In the acquisition process, the information processing terminal 10 sends file request data for requesting the file 3 to the server 11 via the Internet NW1.

The server 11 performs an acquisition relay process based on the file request data. In the acquisition relay process, the server 11 causes the file storage 12 to acquire the request for the file 3, and causes the file storage 12 to send the file 3 to the server 11, to acquire the file 3. The server 11 sends the file 3 that is acquired by the acquisition process, to the information processing terminal 10.

The information processing terminal 10 can acquire the file 3 by being relayed by the server 11. When the file storage 12 is connected to a network without a firewall 13, that is, a so-called global network, there have been cases where a problem arises in the security of the file storage 12 with respect to unauthorized accesses, etc. The file storage 12 is able to block unauthorized accesses, etc., with the firewall 13, and therefore the security is increased.

As illustrated in FIG. 13, when access is blocked by the firewall 13, a relay device performs the process of acquiring the file 3 from the information storage device, on behalf of the device operated by the user. In FIG. 13, the relay device is the server 11.

In the information processing system 1, the information processing terminal 10 may perform the process of deleting the file 3 stored in the information processing terminal 10, when a predetermined period of time passes.

The information processing terminal 10 acquires the file 3 from the file storage 12, etc., by the acquisition process. The file 3 acquired by the acquisition process may include so-called confidential information. Therefore, in terms of security, the period of being stored in the information processing terminal 10 may preferably be short. In this case, when a predetermined period passes after the user A finishes using the file 3, the information processing terminal 10 performs a process of deleting the file 3. By deleting the file 3 when a predetermined period passes, the information processing terminal 10 can reduce the instances of leakage of confidential information due to the downloaded file 3, and security can be increased.

### <Registering in “Favorites”>

In the information processing system 1, there are cases where the information processing terminal 10 is not connected to the server 11, etc., that is, the information processing terminal 10 becomes so-called offline. When the information processing terminal 10 is offline, the information processing terminal 10 cannot execute an acquisition process, and therefore the information processing terminal 10 may only be able to use files, etc., that are stored in the information processing terminal 10.

When the information processing terminal 10 is set to perform a process of deleting the stored file 3 when a predetermined period passes, the information processing terminal 10 is unable to store the file 3 for more than the predetermined period. Thus, the information processing terminal 10 registers, in “favorites”, the file 3 that is specified to be stored in the information processing terminal 10 for a predetermined period or more than the predetermined period (hereinafter, “favorites”), among the downloaded files 3.

When the information processing terminal 10 performs a process of deleting the file 3 that has been downloaded and stored in the information processing terminal 10 when a predetermined period passes, a file 3 that is registered in “favorites” is excluded from the target of the deleting process. That is, a file 3 registered in “favorites” is stored in the information processing terminal 10 for more than the predetermined period. Therefore, by registering the file 3 in “favorites”, the user A is able to use the file 3 when the information processing terminal 10 is offline, etc.

The information processing terminal 10 generates file identification data for identifying the file 3 registered in “favorites”, and manages the generated file identification data.

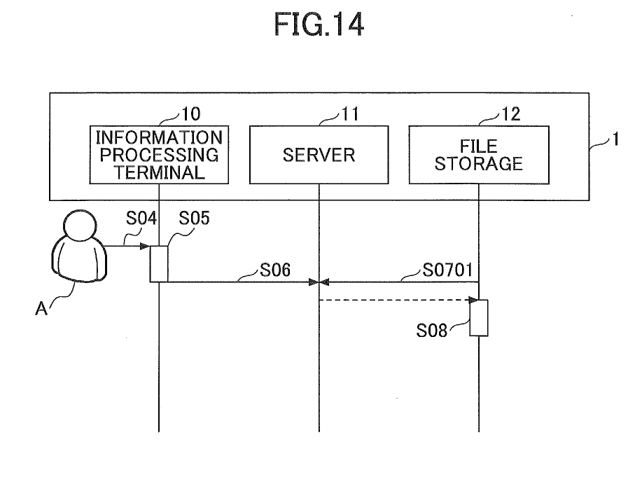

FIG. 14 is a sequence diagram illustrating an example of a process of registering a file in “favorites” by the information processing system 1 according to an embodiment of the present invention. The processes illustrated in FIG. 14 are detailed processes of steps S04 through S08.

In step S04, when the user A performs an operation of specifying the file 3 to be registered in “favorites”, by the information processing terminal 10, the information processing terminal 10 generates file identification data.

In step S05, the information processing terminal 10 generates file identification data for identifying the file 3, which has been specified in step S04.

In step S06, the information processing terminal 10 sends the file identification data generated in step S05, to the server 11.

The instruction to register a file in “favorites” is sent to the file storage 12 by the file identification data. The information processing terminal 10 is unable to directly access the file storage 12. Therefore, the information processing terminal 10 sends an instruction to register a file in “favorites” to the file storage 12, by being relayed by the server 11, similar to the case of downloading the file.

In step S0701, the file storage 12 performs a process of acquiring a request for “favorites” registration. The process of step S0701 corresponds to the process of step S07. By the process of step S0701, the file identification data sent to the server 11 in step S06 is sent to the file storage 12.

In step S08, the file storage 12 stores the file identification data.

The file identification data is data indicated by, for example, the following table 1.

TABLE 1

| | NAME OF REGISTERED | |
|---|---|---|
| | INFORMATION PROCESSING | FILE UPDATE |
| FILE NAME | TERMINAL | TIME AND DATE |
| /user1/file1.doc | INFORMATION PROCESSING | 2014/07/20 |
| | TERMINAL 10A | 9:30:10.0901 |
| /user2/file2.doc | INFORMATION PROCESSING | 2014/08/21 |
| | TERMINAL 10B | 16:47:51.001 |

As indicated in Table 1, the file identification data is data identifying the files 3 registered in “favorites”. As indicated in Table 1, for example, the file name, etc., of the file 3 registered in “favorites” is stored in association with the information processing terminal at which the operation to register the file 3 in “favorites” has been performed in step S04. As the file identification data is stored in the file storage 12, the file storage 12 can identify the file 3 registered in “favorites”, among the downloaded files 3. Furthermore, the file storage 12 can identify the information processing terminal that is registering each file in “favorites”.

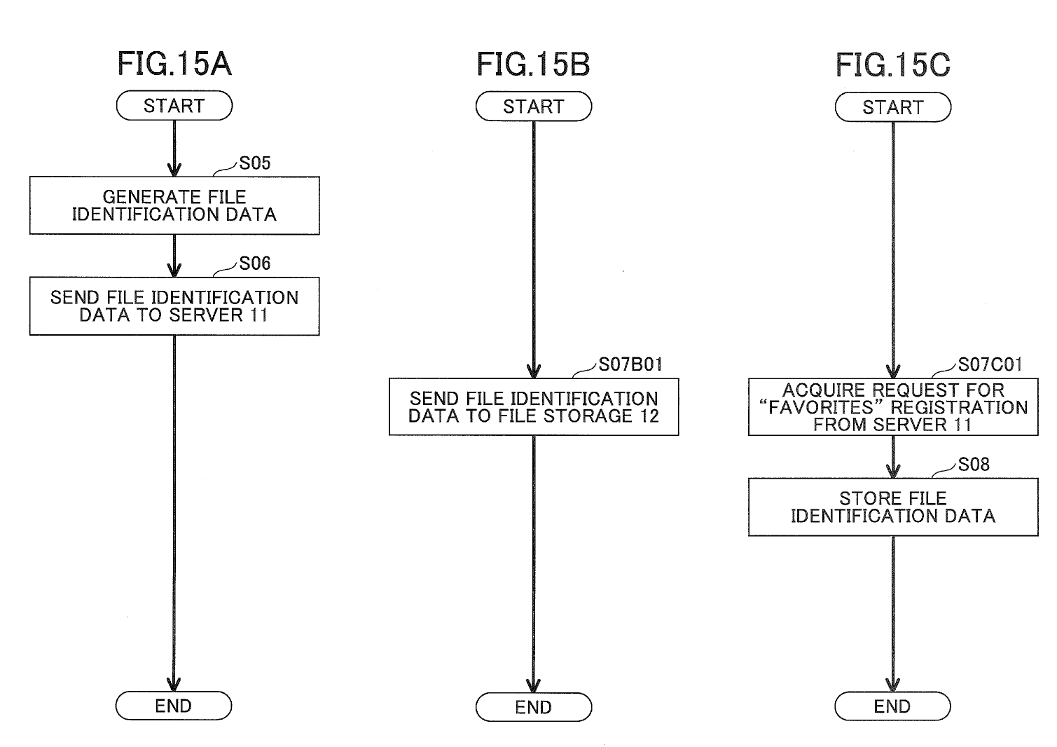

FIGS. 15A through 15C are flowcharts of an example of a process of registering a file in “favorites” performed by the respective devices according to an embodiment of the present invention.

FIG. 15A is a flowchart of an example of a process of registering a file in “favorites” performed by the information processing terminal 10 according to an embodiment of the present invention.

In step S05, the information processing terminal 10 generates file identification data. In step S05, the information processing terminal 10 generates file identification data identifying the file specified by the user A by the operation of step S04.

In step S06, the information processing terminal 10 sends file identification data to the server 11.

FIG. 15B is a flowchart of an example of a process of registering a file in “favorites” performed by the server 11 according to an embodiment of the present invention.

In step S07B01, the server 11 sends the file identification data to the file storage 12. The process of step S07B01 corresponds to the process of step S0701.

FIG. 15C is a flowchart of an example of a process of registering a file in “favorites” performed by the file storage 12 according to an embodiment of the present invention.

In step S07C01, the file storage 12 performs a process of acquiring a request for “favorites” registration from the server 11. The process of step S07C01 corresponds to the process of step S0701.

In step S08, the file storage 12 stores the file identification data.

Note that the information processing, system 1 may use data indicating whether it is possible to register a file in “favorites”. For example, when sending the file 3 to the server 11 in step S0203, the file storage 12 sends data indicating whether the file 3 can be registered in “favorites” to the server 11.

For example, when the file 3 includes confidential information, etc., it may not be preferable in terms of security to store the file 3 in the information processing terminal 10 for a long period of time by being registered in “favorites”. When it is not preferable to register the file 3 in “favorites”, when sending the file to the server 11 in step S0203, the file storage 12 sends, to the server 11, data indicating that the file 3 cannot be registered in “favorites”.

For example, when the user A performs an operation of specifying the file 3 as a file to be registered in “favorites” in step S04, the information processing terminal 10 determines whether it is possible to register the file 3 in “favorites”. When the information processing terminal 10 determines that the file 3 cannot be registered in “favorites”, the information processing system 1 cancels the process of registering the file 3 in “favorites”. The information processing terminal 10 performs a process, etc., of displaying a message indicating that the file 3 cannot be registered in “favorites”, to the user A.

The information processing system 1 cancels the process of registering the file 3 in “favorites”, and therefore when a predetermined period passes, the file 3 is deleted by the information processing terminal 10. By determining whether the file 3 can be registered in “favorites”, the information processing system 1 is able to reduce the instances where files 3 including confidential information, etc., are stored in the information processing terminal 10 for a long period of time, and security is increased.

Furthermore, the determination of whether a file can be registered in “favorites” can be made by the file storage 12.

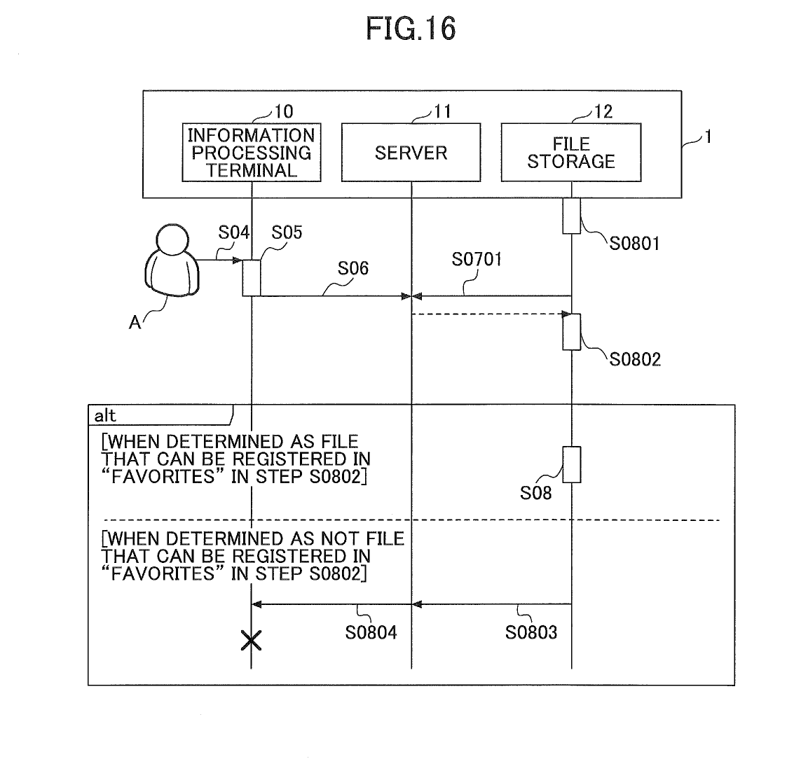

FIG. 16 is a sequence diagram illustrating another example of a process of registering a file in “favorites” by the information processing system 1 according to an embodiment of the present invention.

FIG. 16 is different from the processes of FIG. 14 in that the processes of steps S0801 through S0804 are added. In FIG. 16, the same processes as those of FIG. 14 are denoted by the same step numbers and descriptions thereof are omitted.

In step S0801, the file storage 12 inputs registration determination data indicating whether each file can be registered in “favorites” (hereinafter, simply referred to as “registration determination data”).

The registration determination data is data indicated by, for example, the following table 2.

TABLE 2

| | POSSIBILITY TO REGISTER |
|---|---|
| FILE NAME | IN “FAVORITES” |
| FILE A | OK |
| FILE B | NG |
| FILE C | OK |
| . | . |
| . | . |
| . | . |

As indicated in Table 2, the registration determination data stores indications as to whether each file can be registered in “favorites”, in association with the corresponding file.

For example, among the files 3, it is assumed that the files having the file names of “file A”, “file B”, and “file C” are stored in the file storage 12.

A description is given of an example where “file A” and “file C” are catalogs. A catalog is an example of a file that does not include confidential information, etc. A catalog is an example of a file that can be disclosed outside the company. When “file A” and “file C” are catalogs, etc., the creator, etc., of each file makes a setting that “file A” and “file C” can be registered in “favorites”. When a setting is made that the file can be registered in “favorites”, “OK” is stored in the registration determination data.

When “file B” is a file including confidential information, etc., the creator, etc., of the file makes a setting that “file B” cannot be registered in “favorites”. When a setting is made that the file cannot be registered in “favorites”, “NG” is stored in the registration determination data.

In step S0802, the file storage 12 determines whether the file 3 identified by the file identification data sent in step S0701 can be registered in “favorites”, based on the registration determination data.

When file storage 12 determines that the file can be registered in “favorites” in step S0802 ([when determined as file that can be registered in “favorites” in step S0802]), the file storage 12 proceeds to step S08. When file storage 12 determines that the file cannot be registered in “favorites” in step S0802 ([when determined as file that cannot be registered in “favorites” in step S0802]), the file storage 12 proceeds to step S0803.

In step S0803, the file storage 12 sends message data, etc., indicating that the file that is the target of registration in “favorites” cannot be registered in “favorites”, to the server 11.

In step S0804, the server 11 sends the message data, etc., indicating that the file that is the target of registration in “favorites” cannot be registered in “favorites”, to the information processing terminal 10. For example, the information processing terminal 10 displays message data, etc., sent from the server 11, to the user A. The information processing terminal 10 cancels the process of registering the file that has been set as the target by the operation in step S04 in “favorites”, based on the message data, etc., sent from the server 11.

### <Process of Updating File>

In the information processing system 1, there are cases where the file 3 stored in the file storage 12 is updated by an operation, etc., of correcting the contents of the file 3. When the file 3 is stored in the information processing terminal 10 for a long period of time by being registered in “favorites”, the file 3 stored in the information processing terminal 10 is most often a file in which an update is not applied. That is, the file 3 stored in the information processing terminal 10 by being registered in “favorites” may not be in the latest state.

The process of updating a file is a process of applying an update to the file 3, which is stored in the information processing terminal 10 by being registered in “favorites”, such that the file 3 is updated to the latest state.

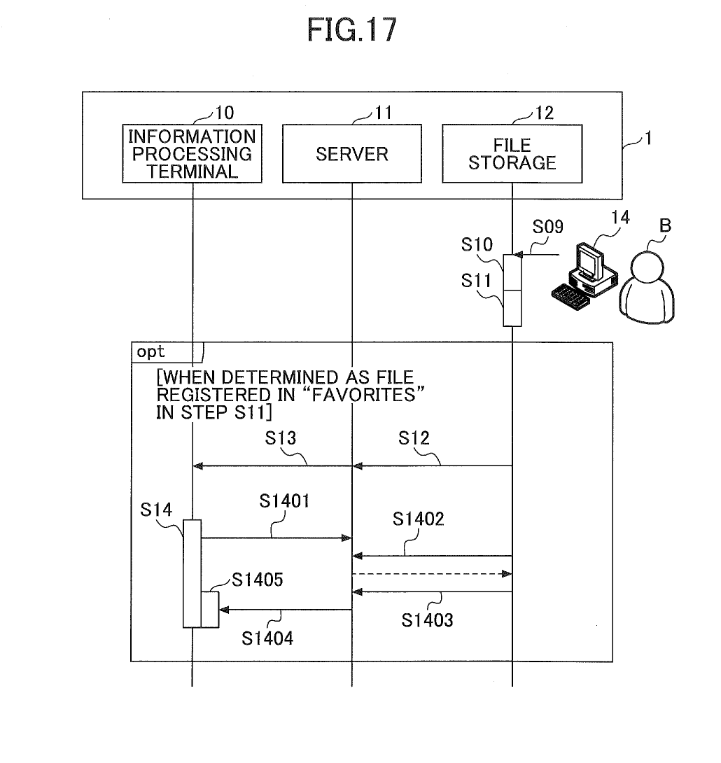

FIG. 17 is a sequence diagram illustrating an example of a process of updating a file by the information processing system 1 according to an embodiment of the present invention.

The processes illustrated in FIG. 17 are detailed processes of steps S12 through S14.

The process of updating a file is performed by the information processing system 1, when the file 3 stored in the file storage 12 is updated by the operation in step S09.

In step S10, the file storage 12 detects the update of the file 3 by the operation in step S09.

In step S11, the file storage 12 determines whether the file 3 that is detected as being updated is registered in “favorites”. In the case of the file identification data of Table 1, in step S11, the file storage 12 determines whether a file having a file name “file1.doc” or “file2.doc” has been updated in step S09, among the files 3 being stored.

When the file storage 12 determines that the file 3 is registered in “favorites” in step S11, the information processing system 1 performs the processes of steps S12 and onward.

The report of steps S12 and S13 is a so-called push notification.

In step S12, the file storage 12 sends, to the server 11, a report indicating that a file identified by the file identification data among stored the files 3, has been updated.

In step S13, the server 11 reports the update report data to the information processing terminal 10, based on the report from the file storage 12. The update report data is data for reporting to the information processing terminal 10 that, among the files 3 stored in the file storage 12, a file identified by the file identification data has been updated. That is, the update report data indicates that the file 3 registered in “favorites” has been updated in the file storage 12. By the update report data, the information processing terminal 10 is able to report to the user A that the file 3 registered in “favorites” needs to be updated.

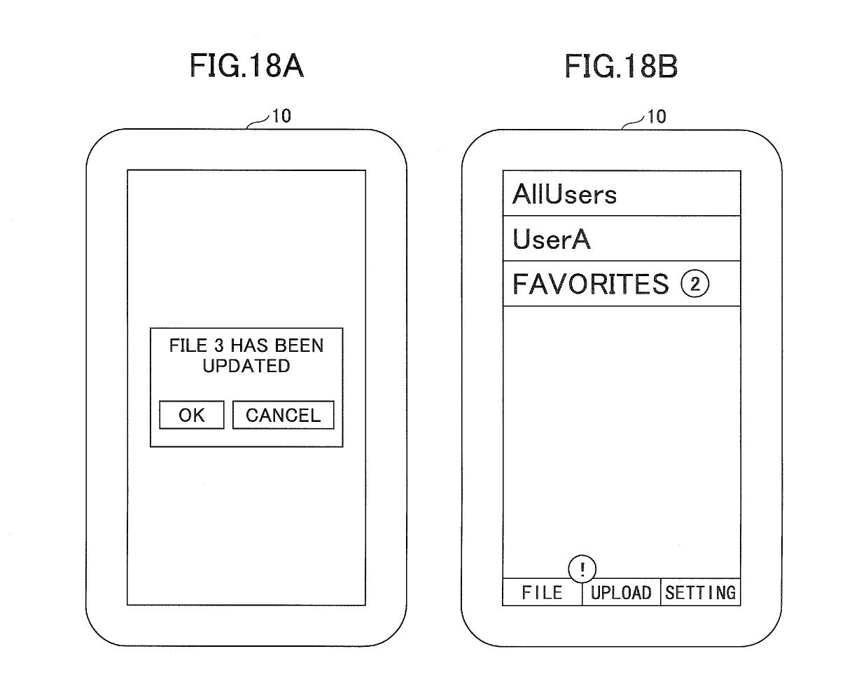

FIGS. 18A and 18B illustrate examples of displays relevant to the report by the information processing terminal 10 according to an embodiment of the present invention.

For example, when the information processing terminal 10 receives the report that the file 3 registered in “favorites” has been updated, as illustrated in FIG. 18A, the information processing terminal 10 displays a report that the file 3 has been updated. Furthermore, when the information processing terminal 10 receives a report when an application is already open, as illustrated in FIG. 18B, the information processing terminal 10 may display, in the “favorites” folder, the number of files for which an update report has been received, and may display, in the “file” button, a mark indicating that there has been an update. Then, when the “favorites” folder is selected or when an updated file in the “favorites” folder is selected, the information processing terminal 10 executes the process of step S14.

In step S14, the information processing terminal 10 performs an update process of updating the file 3 registered in “favorites”. The update process is a process of acquiring update data for updating the file 3 from the file storage 12 by being relayed by the server 11, and updating the file 3 based on the acquired update data, based on the update report data.

The update data is, for example, data of the file 3 that is stored in the file storage 12 after the operation of step S09. The update data may be data that indicates the difference between the file 3 downloaded by the information processing terminal 10 and the file 3 after the operation of step S09. That is, the update data is data for applying the update according to the operation of step S09, to the file 3 stored in the information processing terminal 10. The information processing terminal 10 is unable to directly access the file storage 12, and therefore, in the update process, the update data is acquired by being relayed by the server 11, similar to the acquisition process.

The update process is, for example, the processes of steps S1401 through S1404.

In step S1401, the information processing terminal 10 sends update request data for requesting the update data, to the server 11. The update request data is data for requesting the server 11 to provide update data for updating the file 3 stored in the information processing terminal 10.

The server 11 performs an update relay process, when update request data is sent from the information processing terminal 10. In the update relay process, the server 11 acquires, from the file storage 12, the update data requested by the update request data, and sends the update data acquired from the file storage 12, to the information processing terminal 10.

The update relay process is, for example, the processes of steps S1402 through S1405.

In step S1402, the file storage 12 performs a process of acquiring the request to update the file. By the process of step S1402, the update request data sent to the server in step S1401, is sent to the file storage 12.

In step S1403, the file storage 12 sends the update data to the server 11. In step S1403, the file storage 12 sends the update data based on the operation of step S09 to the server 11, based on the update request data acquired in step S1402.

In step S1404, the server 11 sends the update data sent from the file storage 12 in step S1403, to the information processing terminal 10.

In step S1405, the information processing terminal 10 updates the file 3 based on the update data received from the server 11. For example, when the update data is the latest file 3, in step S1405, the information processing terminal 10 performs the updating by overwriting the stored file 3 with the received update data, etc.

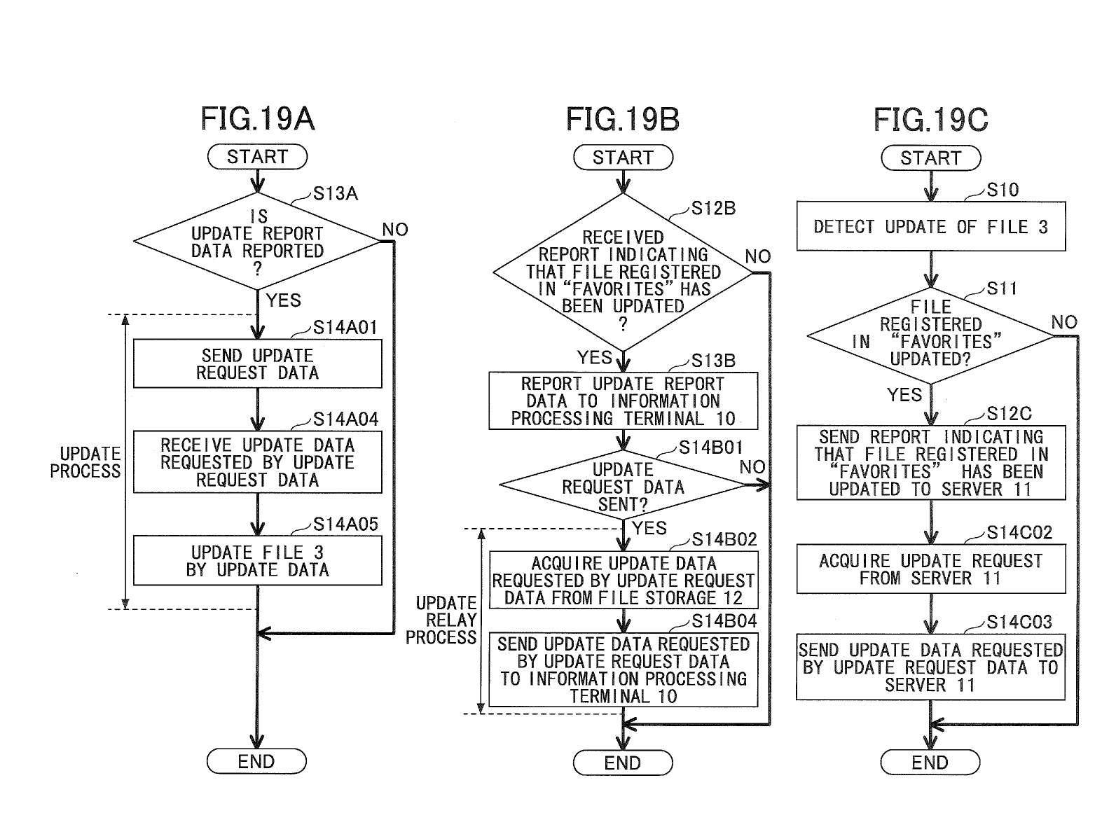

FIGS. 19A through 19C are flowcharts of an example of a process of updating a file performed by the respective devices according to an embodiment of the present invention.

FIGS. 19A through 19C are details of the process of FIG. 17.

FIG. 19A is a flowchart of an example of a process of updating a file performed by the information processing terminal 10 according to an embodiment of the present invention.

In step S13A, the information processing terminal 10 determines whether update report data has been reported. In step S13A, when the information processing terminal 10 determines that update report data has been reported (YES in step S13A), the information processing terminal 10 proceeds to step S14A01. In step S13A, when the information processing terminal 10 determines that update report data has not been reported (NO in step S13A), the information processing terminal 10 ends the process. The process of step S13A corresponds to the process of step S13.

When the update report data is reported, the information processing terminal 10 performs an update process.

The update process is, for example, the processes of steps S14A01, S14A04, and S14A05. By the update process, information processing terminal 10 updates the file 3 registered in “favorites”.

In step S14A01, the information processing terminal 10 sends update request data based on the update report data, to the server 11. The update request data is for requesting update data corresponding to the file 3, for updating the file 3 registered in “favorites” to the latest state.

In step S14A04, the information processing terminal 10 receives update data requested by the update request data.

In step S14A05, the information processing terminal 10 updates the file 3 with the update data. The process of S14A05 corresponds to the process of step S1405.

FIG. 19B is a flowchart of an example of a process of updating a file performed by the server 11 according to an embodiment of the present invention.

In step S12B, the server 11 determines whether a report indicating that the file 3, which corresponds to the file 3 registered in “favorites”, has been updated in the file storage 12, has been received. In step S12B, when the when the server 11 determines that the report has been received (YES in step S12B), the server 11 proceeds to step S13B. In step S12B, when the when the server 11 determines that the report has not been received (NO in step S12B), the server 11 ends the process. The process of step S12B corresponds to the process of step S12.

In step S13B, the server 11 reports update report data to the information processing terminal 10, based on the report from the file storage 12. The process of step S13B corresponds to the process of step S13.

In step S14B01, the server 11 determines whether the update request data has been sent from the information processing terminal 10. In step S14B01, when the server 11 determines that the update request data has been sent (YES in step S14B01), the server 11 proceeds to step S14B02. In step S14B01, when the server 11 determines that the update request data has not been sent (NO in step S14B01), the server 11 ends the process. The process of step S14B01 corresponds to the process of step S1401.

When the update request data is sent from the information processing terminal 10, the server 11 performs an update relay process of acquiring, from the file storage 12, the update data requested by the update request data, and sending the update data acquired from the file storage 12, to the information processing terminal 10.

The update relay process is, for example, the processes of steps S14B02 and S14B04.

In step S14B02, the server 11 performs a process of acquiring, from the file storage 12, the update data requested by the update request data. The process of step S14B02 corresponds to the processes of steps S1402 and S1403.

In step S14B04, the server 11 sends update data, which is acquired based on the update request data, to the information processing terminal 10. The process of step S14B04 corresponds to the process of step S1404.

FIG. 19C is a flowchart of an example of a process of updating a file performed by the file storage 12 according to an embodiment of the present invention.

In step S14C02, the file storage 12 acquires an update request from the server 11. The process of step S14C02 corresponds to the process of step S1402.

In step S14C03, the file storage 12 sends the update data requested by the update request data, to the server 11. The process of step S14C03 corresponds to the process of step S1403.

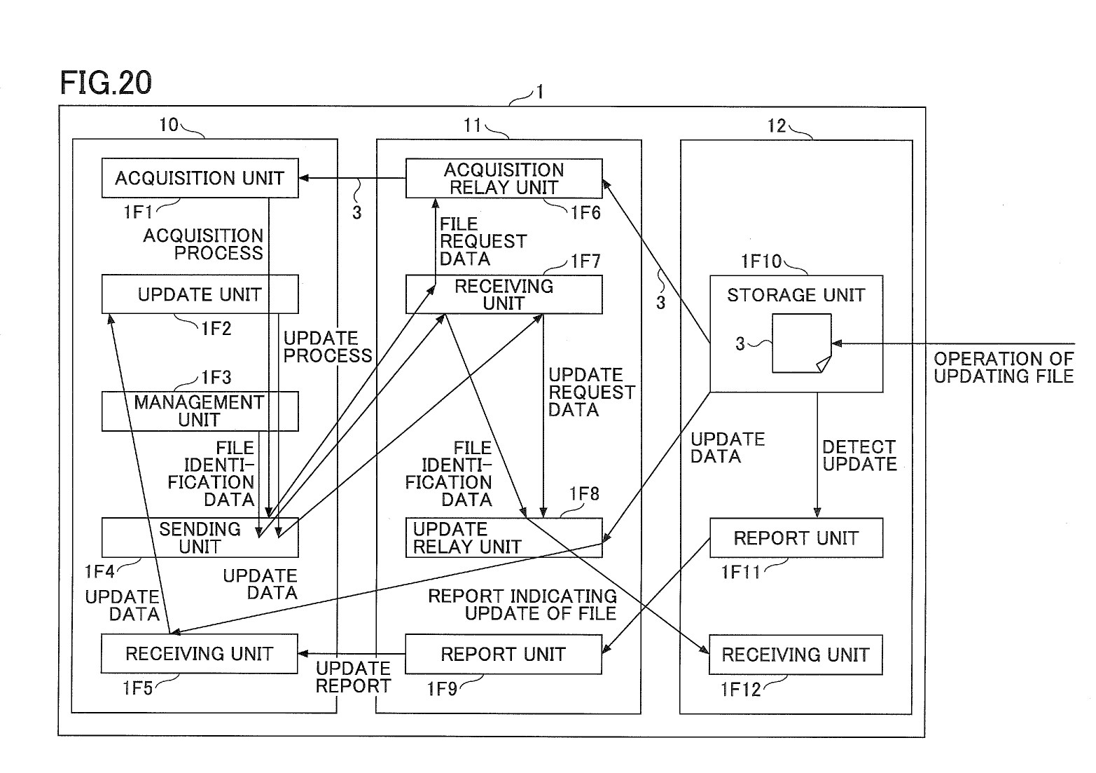

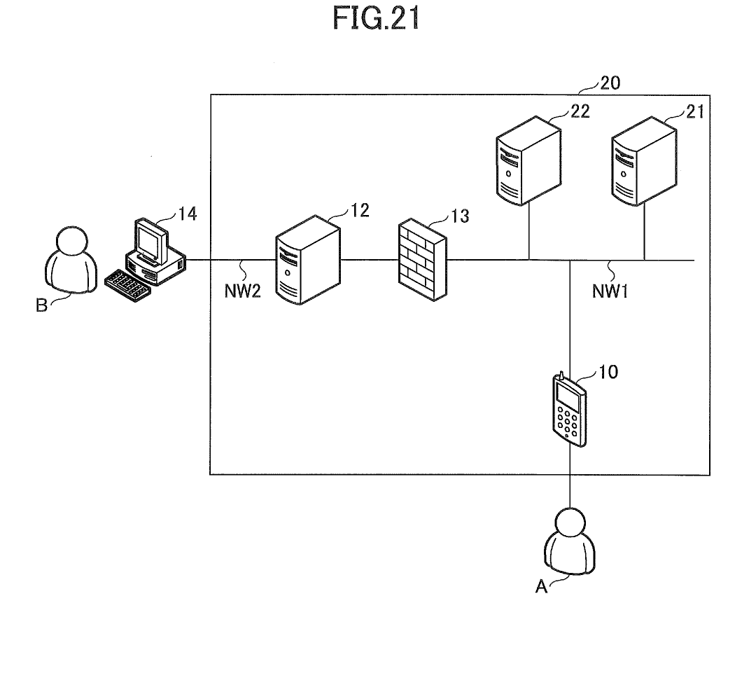

FIG. 20 is a functional block diagram of an example of the functional configuration of the information processing system 1 according to an embodiment of the present invention.

In the information processing system 1, the information processing terminal 10 includes an acquisition unit 1F1, an update unit 1F2, a management unit 1F3, a sending unit 1F4, and a receiving unit 1F5.

The acquisition unit 1F1 performs an acquisition process of acquiring the file 3 from the file storage 12 by being relayed by the server 11. The acquisition unit 1F1 is realized by, for example, the communication I/F 10H4.

The update unit 1F2 performs an update process of updating the file 3 registered in “favorites”. The update unit 1F2 is realized by, for example, the CPU 10H1 and the communication I/F 10H4.

The management unit 1F3 manages file identification data for identifying the file 3 registered in “favorites”. The management unit 1F3 is realized by, for example, the CPU 10H1 and the HD 10H5.

The sending unit 1F4 sends data such as the update request data, the file request data, and the file identification data. The sending unit 1F4 is realized by, for example, the communication I/F 10H4.

The receiving unit 1F5 receives data such as the update report data. The receiving unit 1F5 is realized by, for example, the communication I/F 10H4.

In the information processing system 1, the server 11 includes an acquisition relay unit 1F6, a receiving unit 1F7, an update relay unit 1F8, and a report unit 1F9.

The acquisition relay unit 1F6 performs an acquisition relay process of acquiring the file 3 from the file storage 12 based on file request data, and sending the file 3 acquired from the file storage 12 to the information processing terminal 10. The acquisition relay unit 1F6 is realized by, for example, the communication I/F 11H4.

The receiving unit 1F7 receives data such as the update request data, the file request data, and the file identification data. The receiving unit 1F7 is realized by, for example, the communication I/F 11H4.

The update relay unit 1F8 performs an update relay process of acquiring, from the file storage 12, the update data based on the update request data received by the receiving unit 1F7, and sending the update data acquired from the file storage 12 to the information processing terminal 10. The update relay unit 1F8 is realized by, for example, the communication I/F 11H4.

The report unit 1F9 reports the update report data to the information processing terminal 10, based on the report from the file storage 12. The report sent by the report unit 1F9 is a push notification that is dynamically sent by the server 11, when the report reported from the file storage 12 is received. The report unit 1F9 is realized by, for example, the communication I/F 11H4.

In the information processing system 1, the file storage 12 includes a storage unit 1F10, a report unit 1F11, and a receiving unit 1F12.

The storage unit 1F10 stores data such as the files 3. The storage unit 1F10 is realized by, for example, the HD 11H5.

The report unit 1F11 sends a report to the server 11, when one of the files 3 stored in the storage unit 1F10, which corresponds to a file 3 registered in “favorites”, is updated. The report sent by the report unit 1F11 is a push notification dynamically sent by the file storage 12, when the file 3 corresponding to the file 3 registered in “favorites”, is updated. The report unit 1F11 is realized by, for example, the communication I/F 11H4.

The receiving unit 1F12 receives file identification data for identifying the file 3 registered in “favorites”. The receiving unit 1F12 is realized by, for example, the communication I/F 11H4.

As illustrated with reference to FIG. 13, the information processing terminal 10, etc., cannot directly access the file storage 12. Therefore, the user A cannot access the information processing terminal 10 to find out whether a file 3 corresponding to the file 3 registered in “favorites”, has been updated in the file storage 12. By receiving update report data, the information processing terminal 10 can report to the user A that a file 3 corresponding to the file 3 registered in “favorites”, has been updated in the file storage 12. Based on the update report data, the information processing terminal 10 can update the file 3 registered in “favorites”, by acquiring update data.

In the information processing system 1, the security of the file storage 12 can be increased by having the firewall 13 block any unauthorized accesses, etc. Even when the firewall 13 is used, the information processing terminal 10 is able to acquire the file 3 stored in the file storage 12, by the acquisition relay process by the server 11.

Similarly, in the information processing system 1, even when the firewall 13 is used, the information processing terminal 10 is able to acquire the update data from the file storage 12, by the update relay process by the server 11. By the update data, the information processing terminal 10 is able to update the file 3 registered in “favorites”.

In the information processing system 1, the report reported from the file storage 12 to the server 11 is a push notification sent by the file storage 12. A push notification is sent from the file storage 12 to the server 11, when the file storage 12 detects the update of a file 3 corresponding to the file 3 registered in “favorites”. Therefore, the server 11 is able to quickly detect the update of a file 3 corresponding to the file 3 registered in “favorites”, and the server 11 can quickly report this to the information processing terminal 10.

The report from the server 11 to the information processing terminal 10 by the update report data is a push notification sent by the server 11. The server 11 sends a report to the information processing terminal 10 based on a report from the file storage 12. Therefore, the information processing terminal 10 is able to quickly detect the update of a file 3 corresponding to the file 3 registered in “favorites”, and the information processing terminal 10 can quickly report the update of the file 3 to the user A.

### Second Embodiment

### System Configuration

FIG. 21 illustrates an overall configuration of an example of an information processing system according to a second embodiment of the present invention.

An embodiment of the present invention is not limited to the system configuration illustrated in FIG. 1. An embodiment of the present invention may have the system configuration illustrated in FIG. 21.

FIG. 21 is different from the system configuration illustrated in FIG. 1 in that the server 11 is replaced by a push server 21 and a relay sever 22. In the following, in FIG. 21, the same elements as those of FIG. 1 are denoted by the same reference numerals, and descriptions thereof are omitted.

An information processing system 20 includes the information processing terminal 10, the push server 21, the relay sever 22, and the file storage 12.

The push server 21 makes various reports by a push notification. The push server 21 reports update report data to the information processing terminal 10, when a report indicating that a file 3 corresponding to the file 3 registered in “favorites”, has been updated, is received from the file storage 12. Note that the push server 21 may be constituted by two or more information processing apparatuses, by providing another information processing apparatus that is a push server, etc., in the information processing system 20. The hardware configuration of the push server 21 is, for example, the hardware configuration illustrated in FIG. 3. The functional configuration of the push server 21 is, for example, the functional configuration illustrated in FIG. 6.

The relay sever 22 performs various relay processes. A relay process is, for example, an acquisition relay process, an update relay process, etc. In the information processing system 20, the relay device is the relay sever 22. When the relay sever 22 is directly accessed by the information processing terminal 10, etc., and access to the file storage 12 by the information processing terminal 10 is blocked, the relay sever 22 acquires a file, etc., included in the file storage 12 on behalf of the information processing terminal 10. The hardware configuration of the relay sever 22 is, for example, the hardware configuration illustrated in FIG. 3. The functional configuration of the relay sever 22 is, for example, the functional configuration illustrated in FIG. 6.

In the information processing system 20 according to the second embodiment has the effects as illustrated in FIG. 13 in the process of downloading a file, etc., similar to the information processing system 1 according to the first embodiment. As illustrated in FIG. 13, in the information processing system 20, unauthorized accesses, etc., to the file storage 12 can be blocked by the firewall 13, and security can be increased.

In the information processing system 20, when access by the information processing terminal 10, etc., is blocked by the firewall 13, the relay sever 22 performs a process of acquiring a file, etc., on behalf of the information processing terminal 10. When the information processing system 20 has a configuration as illustrated in FIG. 13, the relay sever 22 becomes the relay device, instead of the server 11.

In the information processing system 20, the relay sever 22 performs the relay process, and therefore the information processing terminal 10, etc., can acquire files, update data, etc., from the file storage 12.

Compared to the information processing system 1 according to the first embodiment, in the information processing system 20, the processes performed by the server 11 can be performed in a parallel manner, in a distributed manner, or in a redundant manner.

Furthermore, the present embodiment is not limited to being realized by the above-described information processing apparatus. The present embodiment may be realized by programs for causing an information processing apparatus or an information processing system including a CPU to execute various processes.

Note that the system configuration using a network described in the embodiments is one example, and there may be various system configurations according to the purpose or the objective. For example, the processes may be performed in a distributed manner, in a redundant manner, or in a parallel manner, by one or more external devices via a network.

The information processing system and the information processing method are not limited to the specific embodiments described herein, and variations and modifications may be made without departing from the spirit and scope of the present invention.

For example, when the information processing terminal 10 can acquire a file from the file storage 12, send the acquired file to another electronic device such as a multifunction peripheral, a printer, a projector, a monitor, an electronic blackboard, or another information processing terminal, and cause the other electronic device to output the file (display output, print output, projection output, etc.), the output of the file registered in “favorites” may be restricted.

For example, the information processing terminal 10 may implement control such that all of the files registered in “favorites” cannot be output. For example, in the display example of the file illustrated in FIG. 9A, the information processing terminal 10 may implement control to prevent a file from being output, by displaying the screen such that the “output” button cannot be selected (non-display, gray-out, etc.). By such a configuration, it is possible to restrict the secondary usage of the file stored in the information processing terminal 10 (for example, distributing to be viewed by outputting to another device).

Furthermore, when the information processing terminal 10 is able to communicate with the file storage 12, the information processing terminal 10 may implement control such that the file registered in “favorites” can be output, and when the information processing terminal 10 is unable to communicate with the file storage 12, the information processing terminal 10 may implement control such that the file registered in “favorites” cannot be output. For example, when the “output” button illustrated in FIG. 9A is selected, the information processing terminal 10 may send a request for a response to the file storage 12 via the server 11, and when a response is sent from the file storage 12, the information processing terminal 10 may execute an output process.

By the above configuration, it is possible to allow output of the file only when the information processing terminal 10 is able to communicate with the file storage 12 (that is, when access can be made to a local network), and therefore both the availability of the file and increased security can be realized.

According to one embodiment of the present invention, an information processing system and an information processing method are provided, which are capable of increasing the securing of a used file, etc.

The present application is based on and claims the benefit of priority of Japanese Priority Patent Application No. 2014-194564, filed on Sep. 25, 2014 and Japanese Priority Patent Application No. 2015-175139, filed on Sep. 4, 2015, the entire contents of which are hereby incorporated herein by reference.

What is claimed is:

1. An information processing system comprising:
an information processing terminal connected to a first network;
at least one information processing apparatus connected to the first network; and
an information storage device connected to a second network other than the first network, the information storage device being configured to store a file, wherein
the information processing terminal includes
an acquisition unit configured to perform an acquisition process of acquiring the file requested by file request data for requesting the file,
a management unit configured to manage file identification data for identifying a file to be stored in the information processing terminal for a predetermined period or more than the predetermined period, among the files acquired by the acquisition process,
a receiving unit configured to receive update report data that is reported when the file stored in the information storage device, which corresponds to the file identified by the file identification data, is updated,
an update unit configured to perform an update process on the file identified by the file identification data among the files acquired by the acquisition process, by update data for updating based on the update report data, and
a sending unit configured to send update request data for requesting the update data in the update process, and the file request data and the file identification data in the acquisition process, wherein
the at least one information processing apparatus includes
a receiving unit configured to receive, from the information processing terminal, the update request data, the file request data, and the file identification data,
an acquisition relay unit configured to perform an acquisition relay process of acquiring the file from the information storage device based on the received file request data, and sending the file acquired from the information storage device to the information processing terminal,
an update relay unit configured to perform an update relay process of acquiring the update data from the information storage device based on the received update request data, and sending the update data acquired from the information storage device to the information processing terminal,
a report unit configured to send a report including the update report data to the information processing terminal based on a report received from the information storage device, and
a sending unit configured to send the received file identification data to the information storage device, and wherein
the information storage device includes
a receiving unit configured to receive the file identification data from the at least one information processing apparatus,
a storage unit configured to store the file, and
a report unit configured to send the report to the at least one information processing apparatus when the file identified by the file identification data, among the stored files, is updated.

2. The information processing system according to claim 1, wherein
the information storage device is protected by a firewall that blocks an access from a device other than a device connected to the second network.

3. The information processing system according to claim 1, wherein
the information processing terminal deletes the file other than the file identified by the file identification data among the files acquired by the acquisition process, when the predetermined period passes.

4. The information processing system according to claim 1, wherein
the report sent by the information storage device is a push notification from the information storage device, and
the report sent by the at least one information processing apparatus is a push notification from the information processing apparatus.

5. The information processing system according to claim 2, further comprising:
a relay device configured to acquire the file and the update data from the information storage device, wherein
the relay device acquires, from the information storage device, the file or the update data stored in the information storage device, when the file request data or the update request data is data for the file stored in the information storage device.

6. An information processing system comprising:
an information processing terminal connected to a first network and to at least one information processing apparatus; and
an information storage device connected to a second network other than the first network, the information storage device being configured to store a file, wherein
the information processing terminal includes
an acquisition unit configured to perform an acquisition process of acquiring the file requested by file request data for requesting the file,
a management unit configured to manage file identification data for identifying a file to be stored in the information processing terminal for a predetermined period or more than the predetermined period, among the files acquired by the acquisition process,
a receiving unit configured to receive update report data that is reported when the file stored in the information storage device, which corresponds to the file identified by the file identification data, is updated,
an update unit configured to perform an update process on the file identified by the file identification data among the files acquired by the acquisition process, by update data for updating based on the update report data, and
a sending unit configured to send update request data for requesting the update data in the update process, and the file request data and the file identification data in the acquisition process, and wherein
the information storage device includes
a receiving unit configured to receive the file identification data from the at least one information processing apparatus,
a storage unit configured to store the file, and
a report unit configured to send a report to the at least one information processing apparatus when the file identified by the file identification data, among the stored files, is updated.

7. An information processing method performed by an information processing system, the information processing system including
an information processing terminal connected to a first network,
at least one information processing apparatus connected to the first network, and
an information storage device connected to a second network other than the first network, the information storage device being configured to store a file, the information processing method comprising:
performing, by the information processing terminal, an acquisition process of acquiring the file requested by file request data for requesting the file;
managing, by the information processing terminal, file identification data for identifying a file to be stored in the information processing terminal for a predetermined period or more than the predetermined period, among the files acquired by the acquisition process;
performing, by the information processing terminal, a first receiving step of receiving update report data that is reported when the file stored in the information storage device, which corresponds to the file identified by the file identification data, is updated;
performing, by the information processing terminal, an update process on the file identified by the file identification data among the files acquired by the acquisition process, by update data for updating based on the update report data;
performing, by the information processing terminal, a first sending step of sending update request data for requesting the update data in the update process, and the file request data and the file identification data in the acquisition process;
performing, by the at least one information processing apparatus, a second receiving step of receiving, from the information processing terminal, the update request data, the file request data, and the file identification data;
performing, by the at least one information processing apparatus, an acquisition relay process of acquiring the file from the information storage device based on the received file request data, and sending the file acquired from the information storage device to the information processing terminal;
performing, by the at least one information processing apparatus, an update relay process of acquiring the update data from the information storage device based on the received update request data, and sending the update data acquired from the information storage device to the information processing terminal;
performing, by the at least one information processing apparatus, a first report step of sending a report including the update report data to the information processing terminal based on a report received from the information storage device;
performing, by the at least one information processing apparatus, a second sending step of sending the received file identification data to the information storage device;
performing, by the information storage device, a third receiving step of receiving the file identification data from the at least one information processing apparatus;
storing, by the information storage device, the file; and
performing, by the information storage device, a second report step of sending the report to the at least one information processing apparatus when the file identified by the file identification data, among the stored files, is updated.
